(19) United States
(12) Patent Application Publication
(10) Pub. No.: US 2023/0109156 A1
(43) Pub. Date: Apr. 6, 2023

(54) PARTICLE, POWDER COMPOSITION, SOLID COMPOSITION, LIQUID COMPOSITION, AND COMPACT

(71) Applicant: Sumitomo Chemical Company, Limited, Chuo-ku, Tokyo (JP)

(72) Inventors: Takashi ARIMURA, Tsukuba-shi, Ibaraki (JP); Yoji MATSUO, Niihama-shi, Ehime (JP); Takuya MATSUNAGA, Tsukuba-shi, Ibaraki (JP); Atsunori DOI, Tsukuba-shi (JP); Satoshi SHIMANO, Tsukuba-shi, Ibaraki (JP)

(21) Appl. No.: 17/909,987

(22) PCT Filed: Mar. 22, 2021
(86) PCT No.: PCT/JP2021/011600

§ 371 Date: Sep. 7, 2022

(30) Foreign Application Priority Data
Mar. 31, 2020 (JP) 2020-062580

(51) Int. Cl. C01G 23/047

(52) U.S. Cl. CPC C01G 23/047; C01P 2002/88; C01P 2002/74; C01P 2006/16; C01P 2002/60

(57) ABSTRACT

This particle contains at least one titanium compound crystal grain, and satisfies requirements 1 and 2. Requirement 1: |dA(T)/dT| of the titanium compound crystal grain satisfies 10 ppm/° C. or more at at least one temperature T1 in a range of −200° C. to 1200° C. A is (a-axis (shorter axis) lattice constant of the titanium compound crystal grain)/(c-axis (longer axis) lattice constant of the titanium compound crystal grain), and each of the lattice constants is obtained by X-ray diffractometry of the titanium compound crystal grain. Requirement 2: the particle contains a pore, and in a cross section of the particle, the pore has an average equivalent circle diameter of 0.8 μm or more and 30 μm or less, and the titanium compound crystal grain has an average equivalent circle diameter of 1 μm or more and 70 μm or less.

### TECHNICAL FIELD

The present invention relates to a particle, a powder composition, a solid composition, a liquid composition, and a compact.

### BACKGROUND ART

In order to reduce the linear thermal expansion coefficient of solid composition, it is known to add a filler having a small linear thermal expansion coefficient value.

For example, Patent Document 1 discloses tungsten zirconium phosphate as a filler exhibiting a negative linear thermal expansion coefficient.

### PRIOR ART DOCUMENTS

### Patent Documents

Patent Document 1: JP-A-2018-2577

### SUMMARY OF THE INVENTION

### Problems to be Solved by the Invention

However, in the conventional material, the linear thermal expansion coefficient is not necessarily sufficiently lowered.

In addition, it is important in applications that the linear thermal expansion coefficient can be controlled according to the type of material used in each application. For example, if the linear thermal expansion coefficient can be controlled in any of inorganic material or organic material, it is easy to design a composite material according to the application.

The present invention has been made in view of the above circumstances. The purpose of the present invention is to provide a particle(s) capable of exerting excellent characteristics of controlling the linear thermal expansion coefficient even when the types of materials vary, and a powder composition, a solid composition, a liquid composition, and a compact using the particles.

### Means for Solving the Problems

As a result of intensive research, the present inventors have arrived at the present invention. Specifically, the present invention provides the following items of the invention.

A particle according to the present invention contains at least one titanium compound crystal grain, and satisfies requirements 1 and 2.

Requirement 1: |dA(T)/dT| of the titanium compound crystal grain satisfies 10 ppm/° C. or more at at least one temperature T1 in a range of −200° C. to 1200° C.

A is (a-axis (shorter axis) lattice constant of the titanium compound crystal grain)/(c-axis (longer axis) lattice constant of the titanium compound crystal grain), and each of the lattice constants is obtained by X-ray diffractometry of the titanium compound crystal grain.

Requirement 2: the particle comprises a pore, and in a cross section of the particle, the pore has an average equivalent circle diameter of 0.8 μm or more and 30 μm or less, and the titanium compound crystal grain has an average equivalent circle diameter of 1 μm or more and 70 μm or less.

The particle may comprise a plurality of titanium compound crystal grains.

The titanium compound crystal grains may have a corundum structure.

The powder composition according to the invention contains the above particles.

The solid composition according to the invention contains the above particles.

The liquid composition according to the invention contains the above particles.

A compact according to the invention is a compact made of a plurality of the particles or made of the powder composition.

### Effect of the Invention

The invention can provide a particle(s) capable of exerting excellent characteristics of controlling the linear thermal expansion coefficient even when the types of materials vary, and a powder composition, a solid composition, a liquid composition, and a compact using the particles.

### BRIEF DESCRIPTION OF THE DRAWINGS

FIG. 1 is a schematic cross-sectional view of a particle according to an embodiment of the present invention.

FIG. 2 is a graph showing the relationship between a temperature T and the a-axis length/c-axis length of titanium compound crystal grain in Example 1 or 2.

### MODE FOR CARRYING OUT THE INVENTION

Hereinafter, preferable embodiments of the invention will be described in detail. However, the invention is not limited to the following embodiments.

### Particle(s)

A particle according to this embodiment contains at least one titanium compound crystal grain, and satisfies requirements 1 and 2.

Requirement 1: |dA(T)/dT| of the titanium compound crystal grain satisfies 10 ppm/° C. or more at at least one temperature T1 in a range of −200° C. to 1200° C.

A is (a-axis (shorter axis) lattice constant of the titanium compound crystal grain)/(c-axis (longer axis) lattice constant of the titanium compound crystal grain), and each of the lattice constants is obtained by X-ray diffractometry of the titanium compound crystal grain.

Requirement 2: the particle comprises a pore, and in a cross section of the particle, the pore has an average equivalent circle diameter of 0.8 μm or more and 30 μm or less, and the titanium compound crystal grain has an average equivalent circle diameter of 1 μm or more and 70 μm or less.

As used herein, the pore(s) means a closed pore(s).

Meanwhile, if there is just one pore, the average equivalent circle diameter of the pore means the equivalent circle diameter of the pore. Likewise, if there is one titanium compound crystal grain, the average equivalent circle diameter of the titanium compound crystal grain means the equivalent circle diameter of the titanium compound crystal grain.

A particle according to this embodiment contains at least one titanium compound crystal grain. The titanium compound crystal grain is a single crystal grain of titanium compound.

The particle(s) according to this embodiment includes at least one titanium compound crystal grain, and may include a polycrystalline particle formed by randomly arranging a plurality of titanium compound crystal grains.

Each particle according to this embodiment has a pore(s). The pore(s) may be a void(s) formed inside a titanium compound crystal grain, or void(s) formed inside a polycrystalline particle formed by randomly arranging a plurality of titanium compound crystal grains contained in the particle. Such a void(s) formed inside each titanium compound crystal grain is referred to as a titanium compound crystal grain pore(s). In addition, such a void(s) formed inside the polycrystalline particle is also referred to as a titanium compound polycrystalline particle pore(s).

In one embodiment of the particle of the invention, at least one titanium compound crystal grain has a pore(s). In another embodiment, the titanium compound polycrystalline particle has a pore(s). In still another embodiment, at least one of the titanium compound crystal grains has a pore(s), and the titanium compound polycrystalline particle has a pore(s).

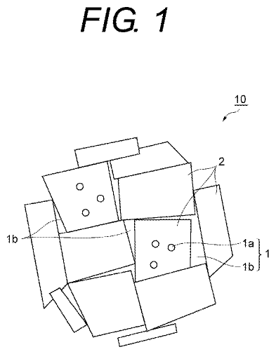

FIG. 1 is a schematic cross-sectional view of a particle according to an embodiment of the present invention. The particle 10 shown in FIG. 1 contains a plurality of titanium compound crystal grains 2. Each titanium compound crystal grain 2 is a single crystal grain. That is, the particle 10 shown in FIG. 1 is a case of polycrystalline particle including a plurality of single crystal grains. Each titanium compound crystal grain 2 satisfies the above requirement 1.

The particle 10 has pores 1. Specific examples of each pore 1 include a pore formed inside one titanium compound crystal grain 2, that is, each pore 1a of the titanium compound crystal grain and each pore formed between a plurality of titanium compound crystal grains 2, that is, each pore 1b of the titanium compound polycrystalline particle. Each pore 1, that is, each pore 1a or each pore 1b is a region all surrounded by titanium compound crystal grain(s). The pore 1a may or may not be present. That is, the pores 1 may be composed of only the pores 1b. The pore 1b may or may not be present. That is, the pores 1 may be composed of only the pores 1a.

In a cross section of the particle 10, the pores 1 have an average equivalent circle diameter of 0.8 μm or more and 30 μm or less, and the titanium compound crystal grains 2 have an average equivalent circle diameter of 1 μm or more and 70 μm or less. If the particle 10 has pores 1a and pores 1b, the average equivalent circle diameter of the pores 1 is calculated based on all the pores including the pores 1a and the pores 1b.

The particle 10 includes a plurality of titanium compound crystal grains 2, but a particle according to this embodiment may be composed of one titanium compound crystal grain 2. That is, the particle according to the embodiment may be a titanium compound crystal grain 2 having a pore(s) 1a. In this case, in a cross section of the particle, the pores 1a have an average equivalent circle diameter of 0.8 μm or more and 30 μm or less, and the titanium compound crystal grain 2 has an equivalent circle diameter of 1 μm or more and 70 μm or less.

The lattice constants in the definition of A are specified by powder X-ray diffractometry. Examples of the analysis method include a Rietveld method and an analysis using fitting by a least-squares method.

As used herein, in the crystal structure specified by powder X-ray diffractometry, an axis corresponding to the smallest lattice constant is defined as a-axis, and an axis corresponding to the largest lattice constant is defined as c-axis. The length of the a-axis and the length of the c-axis of the crystal lattice are defined as an a-axis length and a c-axis length, respectively. As used herein, the lattice constant of the a-axis of the titanium compound crystal grain is the a-axis length, and the lattice constant of the c-axis of the titanium compound crystal grain is the c-axis length.

A(T) is a parameter indicating the magnitude of anisotropy of the length of the crystal axis, and is a function of temperature T (unit: ° C.). The larger the value of A(T), the larger the a-axis length with respect to the c-axis length, and the smaller the value of A, the smaller the a-axis length with respect to the c-axis length.

Here, |dA(T)/dT| represents an absolute value of dA(T)/dT, and dA(T)/dT represents differentiation of A(T) by T (temperature).

Here, as used herein, |dA(T)/dT| is defined by the following formula (D):

|dA(T)/dT|=|A(T+50)−A(T)|/50 (D).

As described above, it is necessary for the particle according to this embodiment to satisfy that |dA(T)/dT| of the titanium compound crystal grain is 10 ppm/° C. or more at at least one temperature T1 in a range of −200° C. to 1200° C. However, |dA(T)/dT| is defined within a range in which the titanium compound crystal grain exists in a solid state. Thus, the maximum temperature of T in the formula (D) is up to a temperature 50° C. lower than the melting point of the titanium compound crystal grain. That is, when the restriction “at at least one temperature T1 in a range of −200° C. to 1200° C.” is given, the temperature range of T in formula (D) is from −200 to 1150° C.

At at least one temperature T1 in a range of −200° C. to 1200° C., |dA(T)/dT| of the titanium compound crystal grain is preferably 20 ppm/° C. or larger and more preferably 30 ppm/° C. or larger. The upper limit of |dA(T)/dT| of the titanium compound crystal grain is preferably 1000 ppm/° C. or less and more preferably 500 ppm/° C. or less.

The phenomenon where the value of |dA(T)/dT| of the titanium compound crystal grain is 10 ppm/° C. or more at at least one temperature T1 means that the change in anisotropy of the crystal structure as accompanied by the temperature change is large.

At at least one temperature T1, dA(T)/dT of the titanium compound crystal grain may be positive or negative, but is preferably negative.

Depending on the type of the titanium compound crystal grain, there is a material, the crystal structure of which changes due to a structural phase transition in a certain temperature range. As used herein, in the crystal structure specified at a certain temperature, an axis corresponding to the smallest lattice constant is defined as a-axis, and an axis corresponding to the largest lattice constant is defined as c-axis. In any of the triclinic, monoclinic, orthorhombic, tetragonal, hexagonal, or rhombohedral crystal system, the a-axis and the c-axis are defined as described above.

The titanium compound constituting the titanium compound crystal grain is preferably a titanium oxide.

More specifically, the titanium compound crystal grain is preferably a crystal grain of titanium compound represented by a composition formula TiOₓ (x=1.30 to 1.66), and more preferably a crystal grain of titanium compound represented by a composition formula TiOₓ (x=1.40 to 1.60).

The titanium compound constituting the titanium compound crystal grain may contain a metal atom other than titanium. Specific examples of the titanium compound include each compound in which part of Ti atoms is substituted with other metal(s) or semimetal element(s) in TiOₓ. Examples of the other metal or semimetal element include B, Na, Mg, Al, Si, K, Ca, Sc, Cr, Mn, Fe, Co, Ni, Cu, Zn, Ga, Sr, Zr, Nb, Mo, Sn, Sb, La, or W. Here, examples of such a compound include LaTiO₃.

The titanium compound crystal grains preferably have a perovskite structure or a corundum structure, and more preferably has a corundum structure.

The crystal system is not particularly limited, and is preferably a rhombohedral crystal system. The space group is preferably assigned to be R-3c.

The average equivalent circle diameter of titanium compound crystal grains and the average equivalent circle diameter of pores in a cross section of the particles can be specified by a method of acquiring and analyzing a backscattered electron diffraction image for the cross section of the particles. Specific examples of the method of obtaining a cross section of the particles and a method of acquiring a backscattered electron diffraction image for the cross section of the particles will be described below.

First, the particles are processed to obtain a cross section. Examples of the method for obtaining a cross section include a method in which part of a solid composition or compact prepared using the particles of this embodiment is cut out and processed with an ion milling apparatus to obtain a cross section of particles contained in the solid composition or compact. Depending on the size of the solid composition or compact, a process such as polishing may be used instead of the process using an ion milling apparatus. The particles may also be processed by using a focused ion beam processing apparatus to obtain a cross section. From the viewpoint of less damage to a sample and obtaining a cross section of many particles at a time, the process using an ion milling apparatus is preferable.

The backscattered electron diffractometry is widely used as a method for measuring a crystal orientation texture, and is usually used in a form in which backscattered electron diffractometry is implemented on a scanning electron microscope. The cross section of the particles as obtained by the process is irradiated with an electron beam, and a backscattered electron diffraction pattern is read with equipment. The obtained diffraction pattern is input into a computer, and the sample surface is scanned while its crystal orientation is simultaneously analyzed. Thus, the crystal is indexed at each measurement point, and the crystal orientation can be determined. At this time, a region having the same crystal orientation is defined as one crystal grain, and the distribution of the crystal grains is mapped. The resulting mapping image is called a grain map, and can be acquired as a backscattered electron diffraction image. Note that when one crystal grain is defined in the present application, a case where the crystal orientation angle difference between adjacent crystals is 10° or less is defined as the same crystal orientation.

The equivalent circle diameter of one titanium compound crystal grain is calculated by an area-weighted average of one crystal grain defined by the above method. Note that the equivalent circle diameter refers to the diameter of a perfect circle with an area corresponding to the area of the corresponding region.

Incidentally, when the equivalent circle diameter of titanium compound crystal grains is calculated using this method, it is preferable to analyze particles including 100 or more crystal grains and use the average to determine the average equivalent circle diameter from the viewpoint of enhancing accuracy.

The average equivalent circle diameter of titanium compound crystal grains in a cross section of the particles may be, for example, 3 μm or more, 5 μm or more, or 10 μm or more. The average equivalent circle diameter of the titanium compound crystal grains in a cross section of the particles may be, for example, 50 μm or less, 30 μm or less, or 20 μm or less. This can further lower the linear thermal expansion coefficient.

Each pore in the cross section of the particles can be observed as a region in which no crystal orientation is assigned and the entire periphery is surrounded by crystal grains in the grain map obtained by the above method. This region includes a pore of the titanium compound crystal grain and a pore of the titanium compound polycrystalline particle.

The equivalent circle diameter of one pore is calculated by an area-weighted average of one pore defined by the above method.

The particle of this embodiment preferably has 20 or more pores.

The average equivalent circle diameter of pores in a cross section of the particles may be, for example, 1.0 μm or more, 1.5 μm or more, or 1.7 μm or more. The average equivalent circle diameter of pores in a cross section of the particles may be, for example, 15 μm or less, 10 μm or less, 5 μm or less, or 3 μm or less. This can further lower the linear thermal expansion coefficient.

The proportion of pores contained in the particle of this embodiment, that is, the porosity of the particle is calculated from values for the area of pores and the area of the titanium compound crystal grains as obtained from the above analysis. Specifically, the porosity is calculated from the following formula (X):

(Porosity of particle)=(Value for area of pores in particle)/(Value for area of titanium compound crystal grains+Value for area of pores in particle) (X).

Note that the porosity is calculated by analyzing all the titanium compound crystal grains for the particles including all the titanium compound crystal grains in the grain map while using this method. However, it is preferable to analyze at least 20 or more titanium compound crystal grains for the grain map in which the particles are present.

The porosity of the particle in this embodiment is preferably 0.1% or more, more preferably 1% or more, still more preferably 3% or more, and particularly preferably 10% or more. The porosity of the particle in this embodiment is preferably 40% or less, more preferably 30% or less, still more preferably 25% or less, and particularly preferably 20% or less. The upper limit and the lower limit from any of the above values may be optionally used in combination. Here, within the above range, the linear thermal expansion coefficient of the solid composition or compact containing the particles of this embodiment may be sufficiently lowered.

If the average equivalent circle diameter of the pores and the average equivalent circle diameter of the titanium compound crystal grains satisfy the above requirements, the particle(s) can have a sufficiently lowered linear thermal expansion coefficient. The mechanism of sufficiently lowering the linear thermal expansion coefficient is speculated such that pores contained in the titanium compound crystal grains change so as to be crushed when the temperature is increased, so that the entire particles change into a contracted form. The reason why the linear thermal expansion coefficient can be sufficiently lowered regardless of the type of material seems to be based on such a mechanism.

The content of the titanium compound crystal grains in the particle of this embodiment may be, for example, 75 mass % or more, 85 mass % or more, 95 mass % or more, or 100 mass % based on the total mass of the particle.

### Process for Producing Particles

The process for producing particles according to this embodiment is not particularly limited. Hereinafter, an example of the process for producing particles according to this embodiment will be described.

The particles in this embodiment may be produced, for example, by a process including the following steps 1, 2, and 3. Inclusion of steps 1, 2, and 3 is likely to make it easy to form the titanium compound crystal grains satisfying requirement 1.

Step 1: a step of mixing TiO₂ and Ti such that a ratio R of the number of moles of Ti atoms in TiO₂ to the number of moles of Ti (the number of moles of Ti atoms in TiO₂/the number of moles of Ti) satisfies 2.0<R<3.0.

Step 2: a step of filling a sintering container with a mixture obtained in step 1 so that a powder density ρ (g/mL) becomes 0.9<ρ.

Step 3: a step of sintering the mixture obtained in step 2 at a temperature of 1130° C. or higher under an inert atmosphere.

### Step 1: Mixing Step

### Ratio R of the Number of Moles of Ti Atoms in TiO₂ to the Number of Moles of Ti

The ratio R of the number of moles of Ti atoms in TiO₂ to the number of moles of Ti represents a mixing ratio between TiO₂ and Ti.

R may be, for example, 2.9 or less from the viewpoint of easily producing the particie(s) of this embodiment.

From the same point of view, R may be, for example, from 2.1 to 2.9, from 2.2 to 2.9, from 2.3 to 2.9, or from 2.5 to 2.9.

By controlling the particle diameters of TiO₂ and Ti used for mixing and adjusting the powder density ρ in the filling step described later, particles satisfying requirement 2 tend to be easily produced. That is, it is considered that the average equivalent circle diameter of pores and/or titanium compound crystal grains contained in the finally obtained particles depends on the particle diameters of TiO₂ and Ti used for mixing and the powder density ρ to be described later. The particle diameters of TiO₂ and Ti used for mixing may be adjusted, for example, by previously crushing, sieving, pulverizing the TiO₂ and Ti used for mixing.

In the mixing step, for example, raw material TiO₂ powder and Ti powder are mixed to prepare raw material mixed powder. For mixing, for example, a ball mill, a mortar, or a container rotary mixer may be used.

As the ball mill, preferred is a rotary cylindrical ball mill in which included TiO₂ powder, Ti powder, and balls are made to flow by rotating the mixing container.

Each ball is a mixing medium for mixing the TiO₂ powder and the Ti powder. A mixing medium having a large average particle diameter may be referred to as a bead, but as used herein, a solid mixing medium is called a ball regardless of the average particle diameter. The balls flow in the mixing container by rotation and gravity of the mixing container. This can cause the TiO₂ powder and the Ti powder to flow to promote mixing.

The shape of each ball is preferably spherical or ellipsoidal from the viewpoint of reducing contamination of impurities due to abrasion of the balls.

The diameter of each ball is preferably sufficiently larger than the particle diameter of TiO₂ powder or the particle diameter of Ti powder. By using such balls, it is possible to promote mixing while preventing pulverization of the TiO₂ powder and the Ti powder. Here, the diameter of each ball refers to the average particle diameter of the balls.

The diameter of each ball is, for example, from 1 mm to 15 mm. If the diameter of the ball is within this range, the TiO₂powder and the Ti powder as raw materials may be mixed without changing the particle diameter. The diameter of each ball placed in the mixing container may be uniform or may be different.

Examples of a material for the balls include glass, agate, alumina, zirconia, stainless steel, chrome steel, tungsten carbide, silicon carbide, or silicon nitride. The balls made of such a material may be used to efficiently mix the powder. Among them, zirconia is preferable because zirconia has relatively high hardness and is thus hardly worn.

The packing ratio of the balls is preferably 10 vol % or more and 74 vol % or less based on the volume of the mixing container.

The container rotary mixer may be a V-type mixer in which two cylindrical containers are combined in a V-shape to form a V-type container as a mixing container, or may be a W-type mixer in which a W (double cone) container having a cylinder between two truncated cones is used as a mixing container.

In the container of the container rotary mixer, the TiO₂ powder and the Ti powder are made to flow by gravity and centrifugal force while being rotated in a direction parallel to the symmetry axis of the container.

In the case of mixing using a ball mill or a container rotary mixer, the packing ratio of the TiO₂ powder and the Tipowder is preferably 10 vol % or more and 60 vol % or less based on the volume of the mixing container. Since there is a space without any TiO₂ powder, Ti powder, or mixing medium in the mixing container, the TiO₂powder, the Ti powder, and the mixing medium flow to promote mixing.

The mixing time is preferably 0.2 hours or more, more preferably 1 hour or more, and still more preferably 2 hours or more from the viewpoint of homogenously mixing the TiO₂ powder and the Ti powder.

Since heat may be generated along with the mixing, it is preferable to cool the mixing container so as to maintain the inside of the mixing container in a certain temperature range during operation of the mixer.

During the mixing, the temperature in the mixing container is preferably from 0° C. to 100° C. and more preferably from 5° C. to 50° C.

### Step 2: Filling Step

### Powder Density

The powder density ρ (g/mL) of a mixture refers to a mass (g) based on the apparent volume (mL) of filled mixture ((mass (g) of filled mixture)/(apparent volume (mL) of filled mixture). The apparent volume includes the volume of gaps between the particles in addition to the actual volume of the mixture.

The powder density may be calculated as, for example, weight/(bottom area×filling height) based on the weight of raw material mixed powder put in a sintering container, the bottom area obtained from the nominal value of the sintering container, and the filling height of the raw material mixed powder.

The sintering container is a container used for sintering. As the sintering container, it is possible to use, for instance, a square case, a cylindrical case, a boat, or a crucible.

The depth from the bottom to the surface of the raw material mixed powder may be measured using, for instance, a ruler, a caliper, or a depth gauge. Since a reference can be set to the same, it is preferable to use a ruler that can use the bottom of the raw material mixed powder as the reference.

The filling height of the raw material mixed powder may be measured after the raw material mixed powder placed in the sintering container is tapped any number of times. By tapping the raw material mixed powder placed in the sintering container any number of times, the filling height of the raw material mixed powder can be optionally changed, and the powder density can be modified even for the same raw material mixed powder.

the powder density of the raw material mixed powder may be increased by applying pressure with a pressing machine. If the pressurized raw material mixed powder has a pellet shape, the raw material mixed powder may be called a raw material mixed pellet.

The raw material mixed pellet may be obtained by applying pressure to the raw material mixed powder with a hand press machine or a cold isostatic press machine.

The powder density of the raw material mixed pellet may be calculated based on, for example, the weight of the raw material mixed pellet, the diameter of the raw material mixed pellet, and the thickness in a direction perpendicular to the diameter.

The diameter and the thickness in a direction perpendicular to the diameter of the raw material mixed pellet may be measured using, for instance, a ruler or a caliper. It is preferable to use a caliper because of high measurement accuracy.

ρ may be, for example, 1.0 g/mL or more, 1.1 g/mL or more, or 1.2 g/mL or more from the viewpoint of easily producing the particles of this embodiment. ρ may be, for example, 4.1 g/mL or less, 3.5 g/mL or less, or 2.9 g/mL or less from the viewpoint of easily producing the particles of this embodiment. From these viewpoints, ρ may be, for example, from 1.0 to 4.1 g/mL, from 1.1 to 3.5 g/mL, or from 1.2 to 2.9 g/mL.

### Step 3: Sintering Step

The sintering is preferably performed in an electric furnace. Examples of the structure of the electric furnace include a box type, a crucible type, a tubular type, a continuous type, a furnace bottom lifting type, a rotary kiln, or a truck type. Examples of the box-type electric furnace include FD-40×40×60-1Z4-18TMP (manufactured by NEMS CO., LTD.). Examples of the tubular electric furnace include a silicon carbide furnace (manufactured by MOTOYAMA).

As described above, the sintering temperature in the sintering step may be 1130° C. or higher. The sintering temperature may be, for example, 1150° C. or higher, 1170° C. or higher, or 1200° C. or higher from the viewpoint of easily producing the particles of this embodiment. The sintering temperature may be, for example, 1700° C. or lower.

The gas constituting the inert atmosphere may be, example, a group 18 element-containing gas.

The group 18 element is not particularly limited, but is preferably He, Ne, Ar, or Kr, and more preferably Ar from the viewpoint of availability.

The gas constituting the inert atmosphere may be a mixed gas of hydrogen and a group 18 element. The content of hydrogen is preferably 4 vol % or less based on the mixed gas because the content is preferably equal to or less than the lower explosive limit.

After the sintering step, the particle diameter distribution is optionally adjusted. This can produce a group of particles according to this embodiment. The particle diameter distribution may be adjusted by, for example, crushing, sieving, or pulverization.

The particles or the group of particles according to this embodiment may be suitably used, for example, as a filler for controlling the value for linear thermal expansion coefficient of a solid composition.

### Above Particle-Containing Powder Composition

An embodiment of the invention is a powder composition containing the above particles and other particles, and the powder composition is a powdery composition. Such a powder composition may be suitably used, for example, as a filler for controlling the linear thermal expansion coefficient of a solid composition described later. The content of the particles in the powder composition is not limited, and a function of controlling the linear thermal expansion coefficient can be exhibited in response to the content. From the viewpoint of efficiently controlling the linear thermal expansion coefficient, the content of the particles may be 75 mass % or more, 85 mass % or more, or 95 mass, or more.

Examples of particles other than the above particles in the powder composition include particles containing titanium compound crystal grains satisfying the requirement 1 and not satisfying the requirement 2; or particles of calcium carbonate, talc, mica, silica, clay, wollastonite, potassium titanate, xonotlite, gypsum fiber, aluminum borate, aramid fiber, carbon fiber, glass fiber, glass flake, polyoxybenzoyl whisker, glass balloon, carbon black, graphite, alumina, aluminum nitride, boron nitride, beryllium oxide, ferrite, iron oxide, barium titanate, lead zirconate titanate, zeolite, iron powder, aluminum powder, barium sulfate, zinc borate, red phosphorus, magnesium oxide, hydrotalcite, antimony oxide, aluminum hydroxide, magnesium hydroxide, zinc carbonate, TiO₂, or TiO.

When a volume-based cumulative particle diameter distribution curve is obtained by a laser diffraction scattering method while a particle diameter at which a cumulative frequency is 50% as obtained by calculating the cumulative frequency from a smaller particle diameter is defined as D50, D50 in the powder composition may be, for example, 0.5 μm or more and 60 μm or less. If D50 is 60 μm or less, the coatability tends to be improved easily. If D50 is 0.5 μm or larger, aggregation is unlikely to occur in the solid composition or compact. Also, homogeneity at the time of kneading with a matrix material such as a resin tends to be easily improved.

One example of the procedure for measuring a volume-based cumulative particle diameter distribution curve by a laser diffraction scattering method will be described below.

As pretreatment, 99 parts by weight of water is added to 1 part by weight of powder composition for dilution, and the mixture is subjected to ultrasonic treatment by using an ultrasonic cleaner. The ultrasonic treatment time is 10 min. The ultrasonic cleaner used may be an NS200-6U, manufactured by NISSEI Corporation. The frequency of the ultrasonic wave is about 28 kHz.

Subsequently, a volume-based particle diameter distribution is then measured by a laser diffraction scattering method. For example, a laser diffraction particle diameter distribution analyzer Mastersizer 2000, manufactured by Malvern Instruments Ltd., can be used for the measurement.

When the titanium compound crystal grains are Ti₂O₃ crystal grains, the refractive index of each Ti₂O₃ crystal grain can be set to 2.40 for measurement.

The D50 in the powder composition is more preferably 40 μm or less, still more preferably 30 μm or less, and particularly preferably 20 μm or less.

The BET specific surface area of the powder composition is preferably 0.1 m²/g or more and 10.0 m²/g or less, more preferably 0.2 m²/g or more and 5.0 m²/g or less, and still more preferably 0.22 m²/g or more and 1.5 m²/g or less. If the BET specific surface area of the powder composition is in such a range, homogeneity at the time of kneading with a matrix material such as a resin tends to be easily improved.

One example of the procedure for measuring the BET specific surface area is shown below.

As pretreatment, drying is performed at 200° C. for 30 min in a nitrogen atmosphere, and then measurement is carried out. The measurement method used is a BET flow method. As measurement conditions, a mixed gas of nitrogen gas and helium gas is used. The percentage of the nitrogen gas in the mixed gas is set to 30 vol %, and the percentage of the helium gas in the mixed gas is set to 70 vol %. The measuring apparatus used may be, for example, a BET specific surface area measuring apparatus Macsorb HM-1201 (manufactured by MOUNTECH Co., Ltd.).

The method for producing the powder composition is not particularly limited, but for example, the above particles and other particles may be mixed, and the particle diameter distribution may be optionally adjusted by, for instance, crushing, sieving, or pulverization.

### Compact

A compact according to this embodiment is a compact made of a plurality of the particles or made of the powder composition. The compact in this embodiment may be a sintered body obtained by sintering a plurality of the particles or the powder composition.

Usually, a compact is obtained by sintering a plurality of the above particles or the powder composition. In this case, it is preferable to perform sintering in a temperature range in which the crystal structure of the particles is maintained.

In order to obtain the sintered body, various known sintering procedures are applicable. As the procedure for obtaining a sintered body, a procedure such as regular heating, hot pressing, or spark plasma sintering may be employed.

Note that the compact according to this embodiment is not limited to the sintered body, and may be, for example, a green compact obtained by pressure molding a plurality of the particles or the powder composition.

By using the compact made of a plurality of the particle or made of the powder composition according to this embodiment, it is possible to provide a member having a low linear thermal expansion coefficient, and it is possible to make very small the dimensional change of the member when the temperature changes.

Thus, the compact can be suitably used for various members used in equipment that are particularly sensitive to a temperature-dependent dimensional change. Further, use of the compact made of a plurality of the particles or made of the powder composition according to this embodiment makes it possible to provide a member having increased volume resistivity.

Furthermore, the compact made of a plurality of the particles or made of the powder composition may be used in combination with another material having a positive linear thermal expansion coefficient to control the linear thermal expansion coefficient of the whole member to be low. For example, the compact made of a plurality of the particles or made of the powder composition of this embodiment may be used in part of a bar material in the lengthwise direction. A member made of a material having a positive linear thermal expansion coefficient may be used for other part(s). In this case, the linear thermal expansion coefficient of the rod in the lengthwise direction can be freely controlled according to the existence ratio between the two materials. For instance, it is also possible to set the linear thermal expansion coefficient of the bar material in the lengthwise direction to zero.

### Solid Composition

A solid composition according to this embodiment contains the above particles. The solid composition contains, for example, the above-mentioned particles and a first material. This solid composition may contain, for example, a plurality of the particles or the powder composition and a first material.

### First Material

The first material is not particularly limited, and examples thereof include a resin, an alkali metal silicate, a ceramic, or a metal. The first material may be a binder material that bonds the above particles or a matrix material that holds the above particles in a dispersed state.

Examples of the resin include a thermoplastic resin or a cured product of a thermosetting resin or active energy ray curable resin.

Examples of the thermoplastic resin include polyolefin (e.g., polyethylene, polypropylene), ABS resin, polyamide (e.g., nylon 6, nylon 6,6), polyamideimide, polyester (polyethylene terephthalate, polyethylene naphthalate), liquid crystal polymer, polyphenylene ether, polyacetal, polycarbonate, polyphenylene sulfide, polyimide, polyetherimide, polyethersulfone, polyketone, polystyrene, or polyetheretherketone.

Examples of the thermosetting resin include an epoxy resin, an oxetane resin, an unsaturated polyester resin, an alkyd resin, a phenol resin (e.g., a novolac resin, a resol resin), an acrylic resin, a urethane resin, a silicone resin, a polyimide resin, or a melamine resin.

Examples of the active energy ray-curable resin include a UV-curable resin or an electron beam-curable resin, and the examples include a urethane acrylate resin, an epoxy acrylate resin, an acrylic acrylate resin, a polyester acrylate resin, or a phenol methacrylate resin.

The first material optionally contains one kind or two or more kinds of the above resin.

From the viewpoint of being able to enhance heat resistance, the first material is preferably an epoxy resin, polyether sulfone, a liquid crystal polymer, polyimide, polyamideimide, or silicone.

Examples of the alkali metal silicate include lithium silicate, sodium silicate, or potassium silicate. The first material may contain one kind or two or more kinds of alkali metal silicate. These materials are preferable because of increased heat resistance.

Examples of the ceramic include, but are not particularly limited to, an oxide-based ceramic (e.g., alumina, silica (including silicon oxide or silica glass), titania, zirconia, magnesia, ceria, yttria, zinc oxide, iron oxide); a nitride-based ceramic (e.g., silicon nitride, titanium nitride, boron nitride); or silicon carbide, calcium carbonate, aluminum sulfate, barium sulfate, aluminum hydroxide, potassium titanate, talc, kaolin clay, kaolinite, halloysite, pyrophyllite, montmorillonite, sericite, mica, amesite, bentonite, asbestos, zeolite, calcium silicate, magnesium silicate, diatomaceous earth, or silica sand. The first material may contain one kind or two or more kinds of the ceramic.

The ceramic is preferable because the heat resistance can be increased. A sintered body may be produced by, for example, spark plasma sintering.

Examples of the metal include, but are not particularly limited to, a simple metal (e.g., aluminum, tantalum, niobium, titanium, molybdenum, iron, nickel, cobalt, chromium, copper, silver, gold, platinum, lead, tin, tungsten), an alloy (e.g., stainless steel (SUS)), or a mixture thereof. The first material may contain one kind or two or more kinds of the metal. Such a metal is preferable because the heat resistance can be increased.

The solid composition of this embodiment preferably contains the above particles and a cured product of an alkali metal silicate or a cured product of a thermosetting resin.

### Additional Components

The solid composition may contain an additional component(s) other than the first material and the above particles or powder composition. Examples of the component include a catalyst. Examples of the catalyst include, but are not particularly limited to, an acidic compound catalyst, an alkaline compound catalyst, or an organometallic compound catalyst. The acidic compound catalyst used may be an acid such as hydrochloric acid, sulfuric acid, nitric acid, phosphoric acid, phosphoric acid, formic acid, acetic acid, or oxalic acid. The alkaline compound catalyst used may be, for example, ammonium hydroxide, tetramethylammonium hydroxide, or tetraethylammonium hydroxide.

Examples of the organometallic compound catalyst include those containing aluminum, zirconium, tin, titanium, or zinc.

The content of the particles in the solid composition is not particularly limited, and a function of controlling the linear thermal expansion coefficient can be exhibited in response to the content. The content of the particles in the solid composition may be 1 wt % or more, 3 wt % or more, 5 wt % or more, 10 wt % or more, 20 wt % or more, 40 wt % or more, or 70 wt % or more. When the content of the particles is increased, the effect of lowering the linear thermal expansion coefficient is easily exerted. The content of the particles in the solid composition may be, for example, 99 wt % or less. The content of the particles in the solid composition may be 95 wt % or less or 90 wt % or less.

The content of the first material in the solid composition can be, for example, 1 wt % or more. The content of the first material in the solid composition may be 5 wt % or more or 10 wt % or more. The content of the first material in the solid composition can be, for example, 99 wt % or less. The content of the first material in the solid composition may be 97 wt % or less, 95 wt % or less, 90 wt % or less, 80 wt % or less, 60 wt % or less, or 30 wt % or less.

The particles according to this embodiment may be included in the solid composition of this embodiment to provide a sufficiently low linear thermal expansion coefficient. This solid composition may be used to obtain a member having a very small dimensional change when the temperature changes. Thus, the solid composition can be suitably used for an optical member or a semiconductor manufacturing equipment member that is particularly sensitive to a temperature-dependent dimensional change.

In particular, the above particles have a sufficiently large absolute value for the maximum negative linear thermal expansion coefficient. Thus, a solid composition (material) having a negative linear thermal expansion coefficient can also be obtained. The wording “having a negative linear thermal expansion coefficient” means that the volume shrinks with linear thermal expansion. A plate may be obtained by bonding an end surface (side surface) of a plate made of a solid composition having a negative linear thermal expansion coefficient to an end surface of a plate made of another material having a positive linear thermal expansion coefficient. In this plate, it is possible to make substantially zero the linear thermal expansion coefficient in a direction perpendicular to the thickness direction of the whole plate.

Further, the temperature of the above particles may be set to a relatively low temperature, for example, less than 190° C., at which an absolute value for the maximum negative linear thermal expansion coefficient is exhibited. Therefore, the linear thermal expansion coefficient of the solid composition in a temperature range of less than 190° C. can be lowered.

### Liquid Composition

A liquid composition according to this embodiment contains the above particles. This liquid composition contains, for example, the above-mentioned particles and a second material. This liquid composition may contain, for example, a plurality of the particles or the powder composition and a second material. The liquid composition is a composition having fluidity at 25° C. This liquid composition can be a raw material for the solid composition described above.

### Second Material

The second material is in a liquid state, and may be obtained by dispersing the particles or the powder composition. The second material can be a raw material for the first material.

For example, if the first material is an alkali metal silicate, the second material may contain an alkali metal silicate and a solvent capable of dissolving or dispersing the alkali metal silicate. If the first material is a thermoplastic resin, the second material may contain a thermoplastic resin and a solvent capable of dissolving or dispersing the thermoplastic resin. If the first material is a cured product of a thermosetting resin or active energy ray curable resin, the second material is a thermosetting resin or active energy ray curable resin before curing.

The thermosetting resin before curing has fluidity at room temperature, and is cured by, for instance, a crosslinking reaction when heated. The thermosetting resin before curing optionally contains one kind or two or more kinds of the above resin.

The active energy ray curable resin before curing has fluidity at room temperature, and is cured by, for instance, a crosslinking reaction caused by irradiation with an active energy ray such as light (e.g., UV) or an electron beam. The active energy ray curable resin before curing contains a curable monomer and/or a curable oligomer, and may further optionally contain a solvent and/or a photoinitiator. Examples of the curable monomer and the curable oligomer are a photocurable monomer and a photocurable oligomer. Examples of the photocurable monomer include a monofunctional or polyfunctional acrylate monomer. Examples of the photocurable oligomer include urethane acrylate, epoxy acrylate, acrylic acrylate, polyester acrylate, or phenol methacrylate.

Examples of the solvent include an organic solvent (e.g., an alcohol solvent, an ether solvent, a ketone solvent, a glycol solvent, a hydrocarbon-based solvent, an aprotic polar solvent) or water. The solvent in the case of the alkali metal silicate is, for example, water.

The liquid composition of this embodiment preferably contains the above particles and an alkali metal silicate or a thermosetting resin before curing.

### Additional Components

The liquid composition may contain an additional component(s) other than the second material and the above particles or powder composition. Examples include the additional component(s) listed for the first material.

The content of the particles in the liquid composition is not particularly limited, and can be set, if appropriate, from the viewpoint of controlling the linear thermal expansion coefficient in the solid composition after curing. Specifically, the content may be like the content of the particles in the solid composition

### Method for Producing Liquid Composition

The method for producing a liquid composition is not particularly limited. For example, the liquid composition can be obtained by stirring and mixing the above particles or powder composition with the second material. Examples of the stirring and mixing process include stirring and mixing using a mixer. Alternatively, it is possible to disperse the particles in the second material by ultrasonic treatment.

Examples of the mixing process used in the mixing step include ball milling, rotation/revolution mixing, impeller turning, blade turning, a turning thin film process, rotor/stator type mixing, colloid milling, high-pressure homogenization, or ultrasonic dispersion. In the mixing step, a plurality of mixing processes may be performed in sequence, or a plurality of mixing processes may be performed simultaneously.

Homogenizing and shearing the composition in the mixing step can enhance the fluidity and deformability of the composition.

### Method for Producing Solid Composition

The above liquid composition may be molded into a desired shape, and the second material in the liquid composition may then be converted to the first material. This makes it possible to produce a solid composition in which the particles and the first material are made into a composite.

For example, the second material may contain an alkali metal silicate and a solvent capable of dissolving or dispersing the alkali metal silicate, or may contain a thermoplastic resin and a solvent capable of dissolving or dispersing the thermoplastic resin. In these cases, after the liquid composition is formed into a desired shape, the solvent is removed from the liquid composition. This can produce a solid composition containing the above particles and the first material (alkali metal salt or thermoplastic resin).

As the procedure for removing the solvent, it is possible to apply a procedure in which the solvent is evaporated by, for example, natural drying, vacuum drying, or heating. From the viewpoint of suppressing generation of coarse foams, it is preferable to remove the solvent while maintaining the temperature of the mixture at a temperature equal to or lower than the boiling point of the solvent during removal of the solvent.

The second material may be a thermosetting resin or active energy ray curable resin before curing. In this case, after the liquid composition is formed into a desired shape, the liquid composition may be cured by heat or active energy rays (e.g., UV).

Examples of the process for forming the liquid composition into a given shape include pouring the liquid composition into a mold or applying the liquid composition onto a surface of a substrate to form a film shape.

In addition, the first material may be a ceramic or a metal. In this case, the following is applicable. A mixture of raw material powder for the first material and the above particles is prepared. Next, the mixture is heated so as to sinter the raw material powder for the first material. This can produce a solid composition containing the first material and the above particles as a sintered body. If necessary, pores of the solid composition can be adjusted by heat treatment such as annealing. As the sintering procedure, a procedure such as regular heating, hot pressing, or spark plasma sintering can be employed.

In the spark plasma sintering, a pulsed current is applied to a mixture of the particles and raw material powder for the first material while the mixture is pressurized. As a result, electric discharge occurs between the raw material powder molecules of the first material, and the raw material powder for the first material can thus be heated and sintered.

The plasma sintering step is preferably performed under an inert (e.g., argon, nitrogen, or vacuum) atmosphere in order to prevent the resulting compound from being altered by contact with the air.

The pressure applied in the plasma sintering step is preferably in a range of more than 0 MPa and 100 MPa or less. To obtain a high-density first material, the pressure applied in the plasma sintering step is preferably 10 MPa or higher and more preferably 30 MPa or higher.

The heating temperature in the plasma sintering step is preferably sufficiently lower than the melting point of the first material of interest.

Furthermore, the size and distribution of pores can be adjusted by heating the solid composition obtained.

The present inventors have found that when the particle(s) containing at least one titanium compound crystal grain satisfies requirements 1 and 2, excellent characteristics of controlling the linear thermal expansion coefficient can be exhibited even when the kinds of materials vary. According to such a particle(s), regardless of the kinds of materials, their value of linear thermal expansion coefficient can be controlled to be sufficiently low.

Each particle of this embodiment preferably comprises a plurality of titanium compound crystal grains. As a result, the linear thermal expansion coefficient tends to be further lowered.

In the particle of this embodiment, the titanium compound crystal grains have a corundum structure.

As a result, the linear thermal expansion coefficient tends to be further lowered.

### EXAMPLES

Hereinafter, the invention will be described in more detail with reference to Examples.

### Crystal Structure Analysis of Titanium Compound Crystal Grain

The crystal structure at 25° C. was analyzed using a powder X-ray diffractometer X'Pert PRO (manufactured by Spectris) under conditions below. The titanium compound crystal grains of each of Examples or Comparative Examples were subjected to powder X-ray diffractometry to obtain a powder X-ray diffraction pattern. Based on the obtained powder X-ray diffraction pattern, the lattice constants were refined by the least-squares method using PDXL2 (manufactured by Rigaku Corporation) software, and two lattice constants, that is, the a-axis length and the c-axis length were calculated.

Measuring apparatus: powder X-ray diffractometer X'Pert PRO (manufactured by Spectris)

X-ray generator: CuKα radiation source with a voltage of 45 kV and a current of 40 mA

Slit: 1°

Scan step: 0.02 deg

Scan range: 10 to 90 deg

Scan speed: 4 deg/min

X-ray detector: one-dimensional semiconductor detector

Measurement atmosphere: Air atmosphere

Sample stage: dedicated glass substrate made of SiO₂

The crystal structure at 150° C. or 200° C. was analyzed using a powder X-ray diffractometer SmartLab (manufactured by Rigaku Corporation) under conditions below. While the temperature was changed, the titanium compound crystal grains of each of Examples or Comparative Examples were subjected to powder X-ray diffraction measurement to obtain a powder X-ray diffraction pattern. Based on the obtained powder X-ray diffraction pattern, the lattice constants were refined by the least-squares method using PDXL2 (manufactured by Rigaku Corporation) software, and two lattice constants, that is, the a-axis length and the c-axis length were calculated.

Measuring apparatus: powder X-ray diffractometer SmartLab (manufactured by Rigaku Corporation)

X-ray generator: CuKα radiation source with a voltage of 45 kV and a current of 200 mA

Slit: slit width of 2 mm

Scan step: 0.02 deg

Scan range: 5 to 80 deg

Scan speed: 10 deg/min

X-ray detector: one-dimensional semiconductor detector

Measurement atmosphere: Ar at 100 mL/min

Sample stage: dedicated glass substrate made of SiO₂

### Temperature Dependent Change of a-Axis Length and c-Axis Length

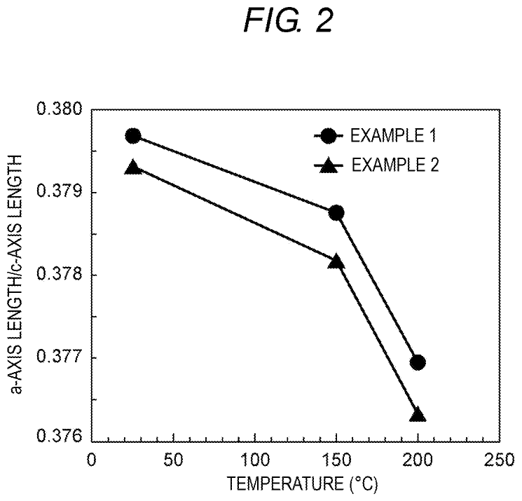

The titanium compound crystal grains of Example 1 or Example 2 were subjected to X-ray diffractometry at each of 25° C., 150° C., or 200° C. The a-axis length, the c-axis length, and the ratio (a-axis length/c-axis length) of the a-axis length to the c-axis length at each temperature are collectively provided in Table 1 for Example 1 and Table 2 for Example 2. The relationship between the a-axis length/the c-axis length and the temperature T, that is, A(T) is depicted in FIG. 2.

TABLE 1

| | c-axis | a-axis | a-axis |
|---|---|---|---|
| Temperature | length | length | length/c-axis |
| (° C.) | (Å) | (Å) | length |
| 25 | 13.619 | 5.171 | 0.3797 |
| 150 | 13.620 | 5.159 | 0.3788 |
| 200 | 13.667 | 5.152 | 0.3770 |

TABLE 2

| | c-axis | a-axis | a-axis |
|---|---|---|---|
| Temperature | length | length | length/c-axis |
| (° C.) | (Å) | (Å) | length |
| 25 | 13.590 | 5.155 | 0.3793 |
| 150 | 13.644 | 5.160 | 0.3782 |
| 200 | 13.690 | 5.152 | 0.3763 |

Using the obtained a-axis length and c-axis length, |dA(T)/dT| at T1=150° C. of the titanium compound crystal grains in Example 1 or Example 2 was calculated by the following formula (D):

|dA(T)/dT|=|A(T+50)−A(T)|/50 (D).

dA(T)/dT=(A(T+50)−A(T))/50 at T1=150° C. of the titanium compound crystal grains in Example 1 was −36 ppm/° C. In addition, at T1=150° C., |dA(T)/dT| was 36 ppm/° C.

dA(T)/dT=(A(T+50)−A(T))/50 at T1=150° C. of the titanium compound crystal grains in Example 2 was −37 ppm/° C. In addition, at T1=150° C., |dA(T)/dT| was 37 ppm/° C.

The titanium compound crystal grains of any of Example I, Example 2, Comparative Example 1, or Comparative Example 2 were assigned to Ti₂O₃ having a corundum structure, and the space group was R-3c.

### To Measure Powder Particle Diameter Distribution

For the powder of each of Examples or Comparative Examples, the particle diameter distribution was measured by the following procedure.

Pretreatment: 1 part by weight of each powder was diluted by adding 99 parts by weight of water, and the mixture was subjected to ultrasonic treatment with an ultrasonic cleaner. The ultrasonic treatment time was set to 10 min, and an NS200-6U, manufactured by NISSEI Corporation, was used as the ultrasonic cleaner. The frequency of the ultrasonic wave was about 28 kHz.

Measurement: the volume-based particle diameter distribution was measured by a laser diffraction scattering method.

Measurement conditions: the refractive index of Ti₂O₃ particles was set to 2.40.

Measuring apparatus: laser diffraction particle diameter distribution analyzer Mastersizer 2000, manufactured by Malvern Instruments Ltd.

From the volume-based cumulative particle diameter distribution curve thus obtained, the particle diameter D50 at which the cumulative frequency was 50% as calculated from the smallest particle diameter was calculated.

### To Measure BET Specific Surface Area of Powder

For the powder of each of Examples or Comparative Examples, the BET specific surface area was measured by the following procedure.

Pretreatment: drying was performed at 200° C. for 30 min in a nitrogen atmosphere.

Measurement: measured by a BET flow method.

Measurement conditions: a mixed gas of nitrogen gas and helium gas was used. The percentage of the nitrogen gas in the mixed gas was set to 30 vol %, and the percentage of the helium gas in the mixed gas was set to 70 vol %.

Measuring apparatus: BET specific surface area measuring apparatus Macsorb HM-1201 (manufactured by MOUNTECH Co., Ltd.)

### To Evaluate Characteristics of Controlling Linear Thermal Expansion Coefficient (of Sodium Silicate Composite Material)

A composite material with sodium silicate was prepared by the procedure below, and the characteristics of controlling the linear thermal expansion coefficient were evaluated.

Here, 80 parts by weight of the powder of each of Examples or Comparative Examples, 20 parts by weight of No. 1 sodium silicate, manufactured by Fuji Chemical Co., Ltd., and 10 parts by weight of pure water were mixed to prepare a mixture.

The resulting mixture was placed in a mold made of polytetrafluoroethylene and cured with the following curing profile.

The temperature was raised to 80° C. in 15 min, held at 80° C. for 20 min, then raised to 150° C. in 20 min, and held at 150° C. for 60 min.

Further, the temperature was raised to 320° C., held for 10 min, and the temperature was then lowered.

The linear thermal expansion coefficient of the solid composition obtained from the above steps, that is, the sodium silicate composite material was measured using the following apparatus.

Measuring apparatus: Thermo plus EVO2 TMA series Thermo plus 8310

The temperature region was set to be from 25° C. to 320° C., and the value for the linear thermal expansion coefficient at 190-210° C. was calculated as a representative value.

Reference solid: alumina

The typical size of a measurement sample of the solid composition was 15 mm×4 mm×4 mm.

For a solid composition of 15 mm×4 mm×4 mm, the longest side was set as the sample length L, and the sample length L(T° C.) at the temperature T° C. was measured. The dimensional change with respect to the sample length (L(30° C.)) at 30° C., that is, ΔL(T° C.)/L(30° C.) was calculated by the following formula (Y):

ΔL(T° C.)/L(30° C.)=(L(T° C.)−L(30° C.))/L(30° C.) (Y).

A slope when the dimensional change ΔL(T° C.)/L(30° C.) was linearly approximated as a function of T from (T−10)° C. to (T+10)° C. by a least-squares method was defined as a linear thermal expansion coefficient α(1/° C.) at T° C.

The value of the linear thermal expansion coefficient α at 200° C. was determined.

Subsequently, the following sodium silicate material was prepared as a control sample.

### Control Sample (Sodium Silicate Material)

First, 3.0 g of No. 1 sodium silicate, manufactured by Fuji Chemical Co., Ltd., was put into a mold made of polytetrafluoroethylene. Next, the temperature was raised to 80° C. in 15 min, and held at 80° C. for 20 min. The mixture was then cured with a curing profile in which the temperature was raised to 150° C. in 20 min and held at 150° C. for 60 min to produce a sodium silicate material.

The linear thermal expansion coefficient a of the sodium silicate material at 200° C. was determined by substantially the same procedure as for the sodium silicate composite material.

For the powder of each of Examples or Comparative Examples, the rate of lowering the linear thermal expansion coefficient of the sodium silicate composite material was calculated by the following calculation formula.

(Rate (%) of lowering the linear thermal expansion coefficient of a sodium silicate composite material)=100×|P−Q|/Q (%).

Here, P represents the linear thermal expansion coefficient α of the sodium silicate composite material at 200° C., and Q represents the linear thermal expansion coefficient α of the sodium silicate material (control sample) at 200° C.

A case where the value for the rate (%) of lowering the linear thermal expansion coefficient of the sodium silicate composite material was 100% or more was considered to be favorable.

### To Evaluate Characteristics of Controlling Linear Thermal Expansion Coefficient (of Epoxy Resin Composite Material)

A composite material with epoxy resin was prepared by the procedure below, and the characteristics of controlling the linear thermal expansion coefficient were evaluated.

Here, 50 parts by weight of the powder of each of Examples or Comparative Examples and 50 parts by weight of epoxy resin 2088E(trade name; manufactured by ThreeBond Co., Ltd.) were mixed to prepare a mixture.

The resulting mixture was placed in a mold made of polytetrafluoroethylene and cured with the following curing profile.

the temperature was raised to 150° C. in 20 min, and held at 150° C. for 60 min.

The linear thermal expansion coefficient of the composition obtained from the above steps, that is, the epoxy resin composite material was measured using the following apparatus.

Measuring apparatus: Thermo plus EVO2 TMA series Thermo plus 8310

The temperature region was set to be from 25° C. to 220° C., and the value for the dimensional change from 30° C. to 220° C. was calculated as a representative value.

Reference solid: alumina

The typical size of a measurement sample of the solid composition was 15 mm×4 mm×4 mm.

For a solid composition of 15 mm×4 mm×4 mm, the longest side was set as the sample length L, and the sample length L(T° C.) at the temperature T° C. was measured. The dimensional change with respect to the sample length (L(30° C.)) at 30° C., that is, ΔL(T° C.)/L(30° C.) was calculated by the following formula (Y):

ΔL(T° C.)/L(30° C.)=(L(T° C.)−L(30° C.))/L(30° C.) (Y).

The dimensional change ΔL(200° C.)/L(30° C.) at 200° C. was determined.

In addition, a slope when the dimensional change ΔL(T° C.)/L(30° C.) was linearly approximated as a function of T from (T−10)° C. to (T+10)° C. by a least-squares method was defined as a linear thermal expansion coefficient α(1/° C.) at T° C.

Subsequently, the following epoxy resin material was prepared as a control sample.

### Control Sample (Epoxy Resin Material)

First, 3.0 g of epoxy resin 2088E (manufactured by ThreeBond Co., Ltd.) was put into a mold made of polytetrafluoroethylene. The material was then cured with a curing profile in which the temperature was raised to 150° C. in 20 min and held at 150° C. for 60 min to produce an epoxy resin material.

The dimensional change ΔL(200° C.)/L(30° C.) at 200° C. and the linear thermal expansion coefficient α at 200° C. of the epoxy resin material were determined by substantially the same procedure as for the epoxy resin composite material.

### Rate of Reducing Dimensional Change

For the powder of each of Examples or Comparative Examples, the rate of reducing a dimensional change in the epoxy resin composite material was calculated by the following calculation formula:

(Rate (%) of reducing a dimensional change in an epoxy resin composite material)=100×|R−S|/S (%).

Here, R represents the dimensional change in the epoxy resin composite material at 200° C., and S represents the dimensional change in the epoxy resin material (control sample) at 200° C.

A case where the rate (%) of reducing the dimensional change was 25% or more was judged to be favorable.

### Rate of Lowering Linear Thermal Expansion Coefficient

For the powder of each of Examples or Comparative Examples, the rate of lowering the linear thermal expansion coefficient of the epoxy resin composite material was calculated by the following calculation formula:

(Rate (%) of lowering the linear thermal expansion coefficient of an epoxy resin composite material)=100×|R′−S′|/S′ (%).

Here, R′ represents the linear thermal expansion coefficient α of the epoxy resin composite material at 200° C., and S′ represents the linear thermal expansion coefficient α of the epoxy resin material (control sample) at 200° C.

A case where the rate (%) of lowering the linear thermal expansion coefficient was 20% or more was judged to be favorable.

### To Measure Average Equivalent Circle Diameter of Titanium Compound Crystal Grains and Average Equivalent Circle Diameter of Pores in Cross Section of Particles

The solid composition of each of Examples or Comparative Examples, which composition was the composite material of the powder and an epoxy resin as obtained by the above method, was processed by an ion milling apparatus to obtain a cross section of particles contained in the solid composition. The processing conditions for the ion milling were as follows.

Apparatus: IB-19520CCP (manufactured by JEOL Ltd.)

Acceleration voltage: 6 kV

Processing time: 5 hours

Atmosphere: air

Temperature: −100° C.

Next, a backscattered electron diffraction image in a cross section of the particles as obtained by the above processing was acquired using a scanning electron microscope. Note that acquisition conditions of the backscattered electron diffraction image were as follows.

Equipment (scanning electron microscope): JSM-7900 F (manufactured by JEOL Ltd.)

Device (backscattered electron diffraction detector): Symmetry (manufactured by Oxford Instruments)

Acceleration voltage: 15 kV

Current value: 4.5 nA

The backscattered electron diffraction pattern read by the device was input into a computer, and the sample surface was scanned while its crystal orientation was analyzed. Thus, the crystal was indexed at each measurement point, and the crystal orientation was determined at each measurement point. At this time, a region having the same crystal orientation was defined as one crystal grain, and the distribution of the crystal grains was mapped. That is, the grain map was acquired as a backscattered electron diffraction image. Note that when one crystal grain was defined, a case where the crystal orientation angle difference between adjacent crystals is 10° or less was defined as the same crystal orientation.

The equivalent circle diameter of one titanium compound crystal grain was calculated by an area-weighted average of one crystal grain defined by the above method. Hundred or more crystal grains were analyzed and averaged to calculate the average equivalent circle diameter.

Each pore in the cross section of the particles was defined as a region in which no crystal orientation was assigned and the entire periphery was surrounded by crystal grains in the grain map obtained by the above method. The equivalent circle diameter of one pore was calculated by an area-weighted average of one pore defined by the above method. Twenty or more pores were analyzed and averaged to calculate the average equivalent circle diameter.

The above analysis makes it possible to calculate a value for the area of pores in the titanium compound crystal grains and the particles. Here, the porosity of particle was calculated from the following formula (X):

(Porosity of particle)=(Value for area of pores in particle)/(Value for area of titanium compound crystal grains+Value for area of pores in particle) (X).

Incidentally, 20 or more titanium compound crystal grains were analyzed.

### Example 1

### Step 1: Mixing Step

To a plastic 1-L polybottle (outer diameter: 97.4 mm) were added 1000 g of 2 mmφ zirconia balls, 161 g of TiO₂ (CR-EL, manufactured by ISHIHARA SANGYC KAISHA, LTD.), and 38.7 g of Ti (<38 μm; manufactured by Kojundo Chemical Lab. Co., Ltd.). The 1-L polybottle was placed on a ball mill stand, and ball mill mixing was performed at a rotation speed of 60 rpm for 4 hours to prepare 200 g of powder 1. The above operation was repeated 5 times to prepare 1000 g of raw material mixed powder 1.

### Step 2: Filling Step

Next, 1000 g of the raw material mixed powder 1 was placed in a sintering container 1 (SSA-T Saya 150 square; manufactured by Nikkato Corporation), and tapping was performed 100 times to set the powder density to 1.3 g/mL.

### Step 3: Sintering Step

The sintering container 1 containing the raw material mixed powder 1 was placed in an electric furnace 1 (FD-40×40×60-1Z4-18TMP, manufactured by NEMS CO., LTD.). The atmosphere in the electric furnace 1 was replaced with Ar, and the raw material mixed powder 1 was then sintered. The sintering program was set such that the temperature was raised from 0° C. to 1500° C. in 15 hours, held at 1500° C. for 3 hours, and lowered from 1500° C. to 0° C. in 15 hours. Ar gas was flowed at 2 L/min during the sintering program operation. After sintering, powder Al was obtained as a group of particles according to an embodiment of the invention.

### Example 2

### Step 1: Mixing Step

An agate mortar and an agate pestle were used to mix, for 15 min, 1.29 g of TiO₂ (CR-EL, manufactured by ISHIHARA SANGYO KAISHA, LTD.) and 0.309 g of Ti (<38 μm, manufactured by Kojundo Chemical Lab. Co., Ltd.). In this way, 1.6 g of raw material mixed powder 2 was prepared.

### Step 2: Filling Step

First, 1.6 g of the raw material mixed powder 2 was put into a cylinder having a φ13 mm, and compressed with a hand press machine 1 (SSP-10A, manufactured by Shimadzu Corporation) at a force of 15 kN for 1 min. This produced a raw material mixed pellet 2 having a powder density of 2.6 g/mL. The raw material mixed pellet 2 was placed on a sintering container 2 (SSA-S boat # 6A, manufactured by Nikkato Corporation).

### Step 3: Sintering Step

The sintering container 2 having the raw material mixed pellet 2 was placed in an electric furnace 2 (silicon carbide furnace, manufactured by Motoyama Corporation). The atmosphere in the electric furnace 2 was replaced with Ar, and the raw material mixed pellet 2 was then sintered. The sintering program was set such that the temperature was raised from 0° C. to 1300° C. in 4 hours and 20 min, held at 1300° C. for 3 hours, and lowered from 1300° C. to 0° C. in 4 hours and 20 min. Ar gas was flowed at 100 mL/min during the sintering program operation. The sintered pellet was pulverized using an agate mortar and an agate pestle to obtain powder A2 as a group of particles according to an embodiment of the invention.

### Comparative Example 1

Ti₂O₃ powder (150 μm pass; purity 99.9%; manufactured by Kojundo Chemical Lab. Co., Ltd.) was used as powder B1 of Comparative Example 1.

### Comparative Example 2

A mixing step was performed under the same conditions as in Example 2 except that TiO₂ (JR-800, manufactured by Tayca Corporation) was used to prepare 1.6 g of raw material mixed powder 3. A filling step and a sintering step were performed under the same conditions as in Example 2 with 1.6 g of the raw material mixed powder 3 to give powder B2.

For the powder of each of Examples or Comparative Examples, Table 3 collectively provides the evaluation results of the |dA(T)/dT| (ppm/° C.) at T1 (150)° C., the particle diameter D50 (μm), and the BET specific surface area (m²/g), and Table 4 collectively provides the evaluation results of the average equivalent circle diameter (μm) of pores, the average equivalent circle diameter (μm) of titanium compound crystal grains, and the porosity (%).

TABLE 3

| | | \|dA(T)/dT\| | | |
|---|---|---|---|---|
| | | at T1 | Particle | BET specific |
| | | (150)° C. | diameter D50 | surface area |
| | Powder | (ppm/° C.) | (μm) | (m²/g) |
| Example 1 | Powder A1 | 36 | 15.3 | 0.23 |
| Example 2 | Powder A2 | 37 | 12.2 | 0.47 |
| Comparative | Powder B1 | — | 41.3 | 0.16 |
| Example 1 | | | | |
| Comparative | Powder B2 | — | 7.8 | 1.51 |
| Example 2 | | | | |

TABLE 4

| | | Average equivalent | |
|---|---|---|---|
| | Average equivalent | circle diameter | |
| | circle diameter | (μm) of titanium | Porosity |
| | (μm) of pores | compound crystal grains | (%) |
| Example 1 | 2.2 | 12.0 | 17.3 |
| Example 2 | 1.7 | 5.6 | 15.5 |
| Comparative | 1.6 | 75.1 | 0.1 |
| Example 1 | | | |
| Comparative | 0.7 | 3.4 | 32.4 |
| Example 2 | | | |

Table 5 collectively provides the evaluation results of the characteristics of controlling the linear thermal expansion coefficient.

TABLE 5

| | Sodium silicate composite material | | Epoxy resin composite material | | | |
|---|---|---|---|---|---|---|
| | or sodium silicate material | | or epoxy resin material | | | |
| | Linear thermal | Rate (%) or | | | Linear thermal | Rate (%) of |
| | expansion | lowering a | | Rate (%) of | expansion | lowering a |
| | coefficient | linear thermal | | reducing a | coefficient | linear thermal |
| | α (200° C.) | expansion | Dimensional | dimensional | α (200° C.) | expansion |
| | (ppm/° C.) | coefficient | change (%) | change | (ppm/° C.) | coefficient |
| Example 1 | −33.9 | 257.7 | 1.08 | 34.5 | 132.0 | 23.8 |
| Example 2 | −27.3 | 227.0 | 1.06 | 35.8 | 116.5 | 32.7 |
| Comparative | −44.4 | 306.5 | 1.25 | 24.2 | 140.4 | 18.9 |
| Example 1 | | | | | | |
| Comparative | 0.6 | 97.2 | 1.14 | 30.9 | 132.9 | 23.3 |
| Example 2 | | | | | | |
| Sodium | 21.5 | — | — | — | — | — |
| silicate | | | | | | |
| material | | | | | | |
| (control) | | | | | | |
| Epoxy resin | — | — | 1.65 | — | 173.2 | — |
| material | | | | | | |
| (control) | | | | | | |

The powders of Example 1 and Example 2 were favorable because regarding the sodium silicate composite material, the rate (%) of lowering the linear thermal expansion coefficient at 200° C. of the sodium silicate composite material with reference to the sodium silicate material was 100% or more. Regarding the epoxy resin composite material, the rate of reducing the dimensional change ΔL(200° C.)/L(30° C.) in the epoxy resin composite material with reference to the epoxy resin material was 25% or more. In addition, the rate of lowering the linear thermal expansion coefficient at 200° C. of the epoxy resin composite material with reference to the epoxy resin material was 20% or more, which was favorable.

The powder of Comparative Example I was favorable because regarding the sodium silicate composite material, the rate (%) of lowering the linear thermal expansion coefficient at 200° C. of the sodium silicate composite material with reference to the sodium silicate material was 100% or more. However, regarding the epoxy resin composite material, the rate (%) of reducing the dimensional change ΔL(200° C.)/L(30° C.) in the epoxy resin composite material with reference to the epoxy resin material was less than 25%. In addition, the rate (%) of lowering the linear thermal expansion coefficient at 200° C. of the epoxy resin composite material with reference to the epoxy resin material was less than 20%.

The powder of Comparative Example 2 was such that regarding the epoxy resin composite material, the rate of reducing the dimensional change ΔL(200° C.)/L(30° C.) in the epoxy resin composite material with reference to the epoxy resin material was 25% or more; and in addition, the rate (%) of lowering the linear thermal expansion coefficient at 200° C. of the epoxy resin composite material with reference to the epoxy resin material was 20% or more, which was favorable. However, regarding the sodium silicate composite material, the rate (%) of lowering the linear thermal expansion coefficient at 200° C. of the sodium silicate composite material with reference to the sodium silicate material was less than 100%.

Any of the sodium silicate composite material or the epoxy resin composite material containing the particles of each Example had a sufficiently lowered linear thermal expansion coefficient, and it has been demonstrated that the particles of each Example have excellent thermal expansion control characteristics. That is, the particles according to this embodiment are found to be applicable to various materials because excellent characteristics of controlling the linear thermal expansion coefficient can be exhibited even when the types of materials vary.

### DESCRIPTION OF REFERENCE SIGNS

1a, 1b, 1 Pore

2 Titanium compound crystal grain

10 Particle

1. A particle comprising at least one titanium compound crystal grain, and satisfying requirements 1 and 2:
requirement 1: |dA(T)/dT|πof the titanium compound crystal grain satisfies 10 ppm/° C. or more at at least one temperature T1 in a range of −200° C. to 1200° C.,
where A is (a-axis (shorter axis) lattice constant of the titanium compound crystal grain)/(c-axis (longer axis) lattice constant of the titanium compound crystal grain), and each of the lattice constants is obtained by X-ray diffractometry of the titanium compound crystal grain; and
Requirement 2: the particle comprises a pore, and in a cross section of the particle, the pore has an average equivalent circle diameter of 0.8 μm or more and 30 μm or less, and the titanium compound crystal grain has an average equivalent circle diameter of 1 μm or more and 70 μm or less.

2. The particle according to claim 1, which comprises a plurality of the titanium compound crystal grains.

3. The particle according to claim 1, wherein the titanium compound crystal grains have a corundum structure.

4. A powder composition comprising the particles according to claim 1.

5. A solid composition comprising the particles according to claim 1.

6. A liquid composition comprising the particles according to claim 1.

7. A compact made of the particles according to claim 1.

8. A compact made of the powder composition according to claim 4.
